(19) United States
(12) Patent Application Publication
(10) Pub. No.: US 2019/0308131 A1
(43) Pub. Date: Oct. 10, 2019

(54) AIR FILTRATION DEVICE UTILIZING SELF-SUPPORTING GRAPHENE MATERIAL

(71) Applicant: Linde ZHANG, Shenzhen (CN)

(72) Inventor: Linde ZHANG, Shenzhen (CN)

(21) Appl. No.: 16/315,657

(22) PCT Filed: Jun. 29, 2017
(86) PCT No.: PCT/CN2017/090725

§ 371 Date: Jan. 7, 2019

(30) Foreign Application Priority Data
Jul. 8, 2016 (CN) 201610539545.9

(51) Int. Cl. B01D 53/04; B01D 39/14

(52) U.S. Cl. CPC B01D 53/04; B01D 39/08; B01D 39/14

(57) ABSTRACT

A gas filtration device includes a self-supporting graphene layer (1) made of a graphene material. The graphene material includes graphene and/or functionalized graphene. The gas filtration device of the present invention enhances the filtration of pollutants in the atmosphere and effectively avoids secondary pollution.

### CROSS REFERENCE TO RELATED APPLICATIONS

This application is the national phase entry of International Application No. PCT/CN2017/090725, filed on Jun. 29, 2017, which is based upon and claims priority to Chinese Patent Application No. 201610539545.9, filed on Jul. 8, 2016, the entire contents of which are incorporated herein by reference.

### TECHNICAL FIELD

The present invention relates to the technical field of gas filtration, and in particular to a gas filtration device. In addition, the present invention further relates to an air filtration system.

### BACKGROUND

With the industrialization of the human society, human's influence on nature has become increasingly significant, and air pollutants have gradually increased. The air pollutants can be roughly divided into two categories: aerosol pollutants and gaseous pollutants. Specifically, the aerosol pollutants include various salts (such as cationic salts of ammonium, potassium, sodium, magnesium, and calcium etc., and anionic salts of sulfate, nitrate, chloride ion, and organic acid radical), metal particles, sand and dust, inorganic carbon particles (such as black carbon, polymer carbon particles, etc.) and organic compounds (such as small droplets of volatile organic compounds, small droplets of polycyclic aromatic hydrocarbons compounds, etc.). The gas pollutants include volatile organic compounds such as nitrogen oxides, sulfur oxides, carbon monoxide, and lower alkanes, etc., as well as hydrogen halides, hydrogen sulfide, ammonia, organic amines, etc.

In the prior art, a High Efficiency Particulate Air (HEPA) filter screen is normally used for filtering air, and the HEPA filter screen is made of a polymer material such as polypropylene and the like, or an inorganic material such as glass fiber and the like. This kind of filter screen can effectively hold back particles in aerosol pollutants, and the removal rate of the particles above 0.3 microns is up to 99.7%. However, for the gaseous pollutants, the removal effect of the HEPA filter screen is poor, which is a problem demanding prompt solution by those skilled in the art.

### SUMMARY

Accordingly, the present invention aims to provide a gas filtration device having a better pollutant removal effect.

In one aspect, the present invention provides a gas filtration device including a self-supporting graphene layer made of a graphene material. The graphene material includes graphene and/or functionalized graphene. The functionalized grapheme includes one or more items from aminated graphene, carboxylated graphene, cyanographene, nitrographene, borate graphene, phosphate graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide.

Further, the self-supporting graphene layer is selected as a self-supporting graphene powder material layer and/or a self-supporting graphene aerogel material layer.

Further, the graphene material includes graphene, graphene oxide, carboxylated graphene and mercapto graphene.

Further, the gas filtration device further includes filtration aiding layers provided on both sides of the self-supporting graphene layer.

Further, the gas filtration device further includes outer covering layers provided outside the filtration aiding layers.

In a second aspect, the present invention provides a manufacturing method of a gas filtration device including the steps of: placing a graphene powder material between filtration aiding layers, and calendering at a pressure from 0.15 MPa to 0.5 MPa to obtain the gas filtration device.

In a third aspect, the present invention further provides another manufacturing method of a gas filtration device including the steps of: calendering a graphene aerogel material at a pressure from 0.15 MPa to 0.5 MPa to obtain the gas filtration device.

In a fourth aspect, the present invention further provides an air filtration system including the gas filtration device described above.

Further, the air filtration system further includes an ultraviolet device arranged between the gas filtration device and an air outlet of an air filter.

After analysis, the inventors have found that the filter materials in the prior art, such as HEPA filter screen, not only have a poor removal effect on the gaseous pollutants, but also tend to cause secondary pollution. The HEPA filter screens have good effects in holding back particulate matters in the aerosol pollutants. However, the surfaces of these particulate matters tend to adsorb a large amount of semi-volatile compounds such as PAHs (polycyclic aromatic hydrocarbons) etc. and VOCs (volatile organic compounds). After the particulate matters are held back on the HEPA filter screen, matters such as PAHs and VOCs etc. are volatilized and released from the particulate matters to pass through the HEPA filter screen with the fresh air in the gaseous form, thereby secondarily polluting the filtered gas.

The gas filtration device in the above technical solution includes a self-supporting graphene layer made of a graphene material, which, on one hand, enhances the filtration effect to pollutants in the atmosphere, and on the other hand, avoids secondary pollution, effectively.

Specifically, graphene material is a two-dimensional material with a large specific surface area and good affinity to free radicals. Therefore, the graphene material has good adsorption property and can effectively adsorb the gaseous pollutants in the atmospheric pollutants. For example, for PAHs, since each carbon atom of the graphene material provides a Pz orbital which involves in the formation of a delocalized π bond on the surface of the graphene with electrons. The surface of the whole graphene may be considered to be covered by the delocalized π bonds, and the surface of the PAHs also has a delocalized π bond system. Thereby, when the PAHs come in contact with the graphene, the π bonds of the two systems stack with each other, thus forming a strong π-π interaction force between the graphene and the PAHs, which makes the graphene material strongly adsorb the PAHs and not easy to detach.

Since the self-supporting graphene layer made of the graphene material is an air permeable structural layer with a certain self-supporting capacity, and has a structure similar to the HEPA filter screen in the interior, a smooth air circulation can be ensured and the aerosol pollutants can be filtered as well. With this structure, particulate matters with larger size can be held back, particulate matters with relatively small size may enter to the inside structure of the self-supporting graphene layer and can be disturbed by different airflows when flowing therein, and are ultimately kept inside the self-supporting graphene layer due to the loss of kinetic energy, and particulate matters with even smaller size are absorbed by the self-supporting graphene layer that has a certain adsorption force.

The functionalized graphene in the graphene material may have a stronger adsorption effect on specific compounds, because the functional groups on the functionalized graphene have a directivity, which makes the functional groups capable of forming chemical bonds (such as ionic bond, covalent bond or secondary bond) with some chemical species with specific structures, so as to form the chemical absorption for such class of chemical species with the specific structures. Compared with the conventional physical adsorption, the chemical adsorption has higher strength and is more pertinent.

As a result, the gas filtration device in the above technical solution can adsorb the gaseous pollutants, as well as the aerosol pollutants in the atmospheric pollutants, and has a strong adsorption effect on the pollutants that are difficult to detach. The combination of various graphene materials may be targeted at different components of atmospheric pollutants to further enhance the filtration effect. Therefore, on one hand, the gas filtration device of the above technical solution preferably enhances the filtering effect on pollutants in the atmosphere, and on the other hand, it also effectively adsorbs semi-volatile compounds such as PAHs and VOCs in the aerosol pollutants, thereby avoiding the secondary pollution.

### BRIEF DESCRIPTION OF THE DRAWINGS

FIG. 1 is a structural schematic diagram of a specific embodiment of a gas filtration device provided by the present invention;

FIG. 2 is a structural schematic diagram of a specific embodiment of a gas pollutant detecting device of the present invention; and

FIG. 3 is a structural schematic diagram of a specific embodiment of a particulate matter detecting device of the present invention.

### DESCRIPTION OF THE REFERENCE DESIGNATORS

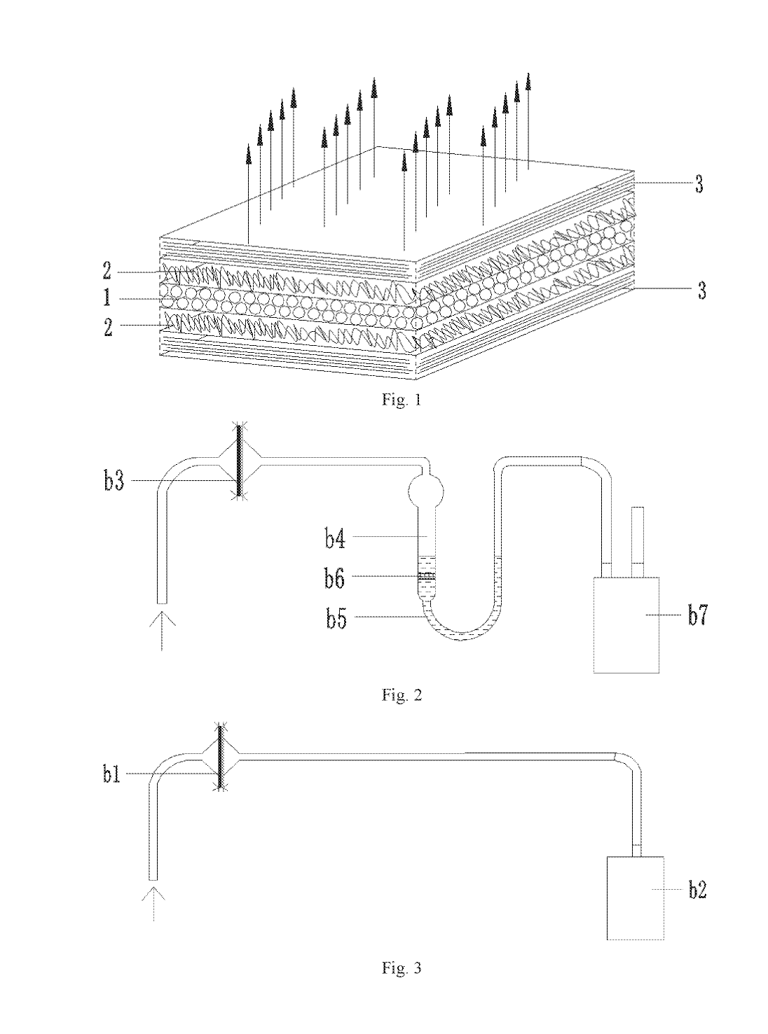

In FIG. 1: self-supporting graphene layer—1; filtration aiding layer—2; outer covering layer—3.

In FIGS. 2 and 3: gas filtration devices—b1, b3; air detector—b2; U-shaped absorbing tube—b4; absorption solvent—b5; aluminum oxide sieve plate—b6, air sampling pump—b7.

### DETAILED DESCRIPTION OF THE EMBODIMENTS

In the description of the present invention, it should be understood that the orientations or positional relationships indicated by the terms “upper”, “lower”, “front”, “rear”, “left”, “right”, “top”, “bottom”, “inside”, “outside”, etc. are based on the orientations or positional relationships shown in the drawings, which are merely intended to facilitate the description of the present invention and simplify the description, rather than indicate or imply that the device or element referred to must have a specific orientation, be constructed and operated in a specific orientation. Thus, these terms cannot be understood as limitations of the present invention.

It should be noted that the embodiments of the present invention and the features of the embodiments may be combined with each other without conflict. The present invention will be described in detail below with reference to the drawings in combination with the embodiments.

After analysis, the inventor have found that the filter materials in the prior art, such as HEPA filter screen, not only have a poor removal effect on the gaseous pollutants, but also tend to cause secondary pollution. The HEPA filter screens have good effects in holding back particulate matters in the aerosol pollutants. However, the surfaces of these particulate matters tend to adsorb a large amount of semi-volatile compounds such as PAHs (polycyclic aromatic hydrocarbons) etc. and VOCs (volatile organic compounds). After the particulate matters are held back on the HEPA filter screen, matters such as PAHs and VOCs etc. are volatilized and released from the particulate matters to pass through the HEPA filter screen with the fresh air in the gaseous form, thereby secondarily polluting the filtered gas.

Therefore, in a specific embodiment of the present invention, a gas filtration device is first provided, which includes a self-supporting graphene layer 1 made of a graphene material. The graphene material includes graphene and/or functionalized graphene. The functionalized grapheme includes one or more items from aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide.

The self-supporting graphene layer 1 described above refers to a graphene layer which has a certain self-supporting capability and can maintain a specific structure even without being supported by an external force. The self-supporting graphene layer 1 can be obtained by calendering the graphene material under a certain pressure. The calendering is a processing method which refers to a process in which a raw material passes through a roller gap between two rollers which are relatively rotated and horizontally disposed to produce products such as film etc.

The gas filtration device described above includes a self-supporting graphene layer 1 made of a graphene material, which, on one hand, enhances the filtration effect to pollutants in the atmosphere, on the other hand, avoids secondary pollution, effectively.

Specifically, graphene material is a two-dimensional material with a large specific surface area and good affinity to free radicals. Therefore, the graphene material has good adsorption property and can effectively adsorb the gaseous pollutants in the atmospheric pollutants. For example, for PAHs, since each carbon atom of the graphene material provides a Pz orbital which involves in the formation of a delocalized a bond on the surface of the grapheme with electrons. The surface of the whole graphene may be considered to be covered by the delocalized π bonds, and the surface of the PAHs also has a delocalized π bond system. Thereby, when the PAHs come in contact with the graphene, the π bonds of the two systems stack with each other, thus forming a strong π-π interaction force between the graphene and the PAHs, which makes the graphene material strongly adsorb the PAHs and not easy to detach.

Since the self-supporting graphene layer 1 made of the graphene material is an air permeable structural layer with a certain self-supporting capacity, and has a structure similar to the HEPA filter screen in the interior, a smooth air circulation can be ensured and the aerosol pollutants can be filtered as well. With this structure, particulate matters with larger size can be held back, particulate matters with relatively small size may enter to the inside structure of the self-supporting graphene layer 1 and be disturbed by different airflows when flowing therein, and are ultimately kept inside the self-supporting graphene layer 1 due to the loss of kinetic energy, and particulate matters with even smaller size are absorbed by the self-supporting graphene layer 1 that has a certain adsorption force.

The functionalized graphene in the graphene material may have a stronger adsorption effect on specific compounds, because the functional groups on the functionalized graphene have a directivity, which makes the functional groups capable of forming chemical bonds (such as ionic bond, covalent bond or secondary bond) with some chemical species with specific structures, so as to form the chemical absorption for such class of chemical species with the specific structures. Compared with the conventional physical adsorption, the chemical adsorption has higher strength and is more pertinent.

As a result, the above-mentioned gas filtration device can adsorb the gaseous pollutants, as well as the aerosol pollutants in the atmospheric pollutants, and has a strong adsorption effect on the pollutants that are difficult to detach. The combination of various graphene materials may be targeted at different components of atmospheric pollutants to further enhance the filtration effect. Therefore, on one hand, the above-mentioned gas filtration device preferably enhances the filtering effect on pollutants in the atmosphere, and on the other hand, it also effectively adsorbs semi-volatile compounds such as PAHs and VOCs in the aerosol pollutants, thereby avoiding the secondary pollution.

Further, in another embodiment, the self-supporting graphene layer 1 is selected as a self-supporting graphene powder material layer and/or a self-supporting graphene aerogel material layer.

The self-supporting graphene powder material layer refers to the self-supporting graphene layer 1 obtained by calendering the powder of one or more of the above graphene materials under a certain pressure. The self-supporting graphene aerogel material layer refers to the self-supporting graphene layer 1 obtained by calendering the aerogel of one or more of the above graphene materials under a certain pressure. The graphene powder material and the graphene aerogel material may be produced by a known method such as a redox method, a hydrothermal method, a drying and pyrolysis method, a chemical vapor deposition method, a physical exfoliation method, a solvent exfoliation method, etc.

Although the self-supporting graphene layers 1 made of graphene materials of different states all have the above-mentioned common advantages, they also have some different filtering characteristics, and a more targeted combination may be made depending on the operating conditions and the filtering targets. For example, it can be told from the detection results in embodiment 10 that the gas filtration device including the self-supporting graphene aerogel material layer and the gas filtration device including the self-supporting graphene powder material layer have different focus on the pollutants when filtering the gas. Both of the self-supporting graphene aerogel material layer and the self-supporting graphene powder material layer have good removal effects on semi-volatile compounds such as PAHs etc., VOCs, inorganic gases, heavy metals, and suspended particles. However, the gas filtration device including the self-supporting graphene aerogel material layer has a relatively better removal effect on semi-volatile compounds such as PAHs etc., the removal rate is almost 100%. While, the gas filtration device including the self-supporting graphene powder material layer has a better removal effect on VOCs, heavy metals and suspended particles.

Preferably, in a specific embodiment, the graphene material described above includes graphene, graphene oxide, carboxylated graphene and mercapto graphene.

Different functionalized graphene can form chemical bonds (e.g. ion bonds, covalent bonds or secondary bonds) with chemical species with certain specific structures because of different functional groups, so that the chemical species with the specific structures can form chemical adsorptions. For example, the graphene has a strong adsorption capacity for PAHs; the graphene oxide has a strong adsorption capacity for formaldehyde; the carboxylated graphene is a graphene modified by a weakly acidic group, so it has a strong adsorption capacity for alkaline substances (mainly including nitrogenous compounds such as ammonia, nitrogen dioxide, etc.); and the mercapto graphene has a strong adsorption capacity for heavy metals (such as lead, mercury, etc.). Thereby, the self-supporting graphene layer 1 including the above-mentioned graphene materials and the gas filtration device have better adsorption capability on PAHs, formaldehyde, alkaline substances, and heavy metals in the air, at the same time. The mass ratio of the four components may be adjusted according to the target gas for filtration. The detection results of embodiment 10 also show that when the graphene material includes the graphene, the graphene oxide, the carboxylated graphene and the mercapto graphene, the effects of removing VOCs such as formaldehyde, etc., inorganic gases such as ammonia, etc., heavy metal such as lead, etc., and suspended particles by the gas filtration device described above is further improved.

Referring to FIG. 1, further, in another embodiment, the gas filtration device may further include filtration aiding layers 2 provided on both sides of the self-supporting graphene layer 1.

The filtration aiding layers 2 are respectively provided on both sides of the self-supporting graphene layer 1, which can assist the filtration of the self-supporting graphene layer 1, thereby achieving the effect of a coarse filtration. A part of the pollutants are first filtered through the filtration aiding layers 2, which, on one hand, improves the filtration effect of the whole gas filtration device, and on the other hand, helps to extend the filtration saturation time of the self-supporting graphene layer 1. As a result, the replacement frequency is reduced, and the use cost is reduced. The detection results of embodiment 10 also show that when the gas filtration device includes the filtration aiding layer 2, the effect of removing suspended particles, especially PM2.5, is further improved.

In addition, even though the self-supporting graphene layer 1 in the gas filtration device has a certain self-supporting capacity, the stability still may be further improved. The use of the filtration aiding layer 2 may also play the role of assisting in stabilizing the structure of the self-supporting graphene layer 1, and further functions as a supporting layer.

Preferably, the materials having good gas permeability, filterability and support are used, which include one or more items of polypropylene needle punched nonwoven fabric, polypropylene spun-laced nonwoven fabric, polypropylene short staple filter cloth, polypropylene long staple filter cloth, polyterephthalate needle punched nonwoven fabric, polyterephthalate spun-laced nonwoven fabric, polyester long staple filter cloth, polyester staple fiber filter cloth, pure cotton needle punched non-woven fabric, pure cotton spun-laced non-woven fabric, pure cotton long staple filter cloth, pure cotton staple fiber filter cloth, polypropylene filter paper, glass fiber, polypropylene-polyethylene terephthalate composite filter paper, melt-blown polyester non-woven fabric, melt-blown glass fiber, microporous ceramic filter plate, microporous polypropylene filter plate, cellulose acetate tow filter element, polypropylene tow filter element and cotton filter element.

Referring to FIG. 1, in another specific embodiment, the gas filtration device may further include an outer covering layer 3 provided outside the filtration aiding layer 2.

The outer covering layer 3 is provided outside the filtration aiding layer 2, namely, the filtration aiding layer 2 and the self-supporting graphene layer 1 are covered by the filtration aiding layer 2 at the outermost surface. The outer covering layer 3 mainly plays a role of stabilizing, supporting and maintaining the gas permeability. Preferably, materials having better structural strength and gas permeability are used, which include one or more items of pure cotton gauze, pure cotton crepe cloth, pure cotton long staple filter cloth, pure cotton staple fiber filter cloth, polypropylene long staple filter cloth, polypropylene short staple filter cloth, polypropylene frame and polyethylene frame.

In another aspect, in another specific embodiment, the present invention further provides a manufacturing method of a gas filtration device which includes the steps of: placing a graphene powder material between the filtration aiding layers 2, and calendering at a pressure ranges from 0.15 MPa to 0.5 MPa to obtain the gas filtration device.

In another specific embodiment, the present invention further provides another manufacturing method of a gas filtration device which includes the steps of: calendering a graphene aerogel material at a pressure ranges from 0.15 MPa to 0.5 MPa to obtain the gas filtration device.

Since the graphene powder material is not easy to shape, the graphene powder material is placed between the filtration aiding layers 2, sandwiched by the filtration aiding layers 2, and then calendered under a pressure ranges from 0.15 MPa to 0.5 MPa to obtain a gas filtration device having a better filtering effect. The detection results of embodiment 10 also show that the differences in calendering pressure when preparing the gas filtration device have an effect on the removal rate of the pollutants. When the calendering pressure is lower than 0.15 MPa or higher than 0.5 MPa, although the gas filtration device as a whole still has a good effect on removing the pollutants, the filtration effect is slightly lowered than that of the calendering pressure ranges from 0.15 MPa to 0.5 MPa.

In addition, another embodiment of the present invention further provides an air filtration system which includes the above-mentioned gas filtration device.

The gas filtration device has the above advantages, so the air filtration system having the above-mentioned gas filtration device also has corresponding technical effects, thus the details will not be repeated herein.

In another specific embodiment, the air filtration system described above further includes an ultraviolet device arranged between the gas filtration device and an air outlet of the gas filter.

Since a large number of bacteria and viruses are adsorbed on the pollutants, and the gas filtration device intercepts and filters the pollutants, the bacteria and viruses are attached to the gas filtration device. The bacteria and viruses accumulate as the use time of the air filtration device increases, which tends to secondarily pollute the filtered air. With the ultraviolet device arranged between the gas filtration device and an air outlet of the gas filtration device, the bacteria and viruses in the gas passed through the gas filtration device can be effectively killed.

The solutions of the present invention are further described below in combination with the specific embodiments. The materials, reagents, instruments and the like used in the following embodiments are commercially available unless otherwise specified.

### Embodiment 1: Method for Preparing Gas Filtration Device

The single-layer graphene aerogel was used as a raw material, and the graphene aerogel was calendered under a pressure of 0.15 MPa to obtain a sheet, then the sheet was cut to obtain a filtration device including a self-supporting graphene aerogel layer.

### Embodiment 2: Method for Preparing Gas Filtration Device

The single-layer graphene aerogel was used as a raw material, and the graphene aerogel was calendered under a pressure of 0.6 MPa to obtain a sheet, then the sheet was cut to obtain a filtration device including a self-supporting graphene aerogel layer.

### Embodiment 3: Method for Preparing Gas Filtration Device

The graphene powder was used as a raw material, and the graphene powder was calendered under a pressure of 0.5 MPa to obtain a sheet, then the sheet was cut to obtain a filtration device including a self-supporting graphene powder layer.

### Embodiment 4: Method for Preparing Gas Filtration Device

The graphene powder was used as a raw material, and the graphene powder was calendered under a pressure of 0.1 MPa to obtain a sheet, then the sheet was cut to obtain a filtration device including a self-supporting graphene powder layer.

### Embodiment 5: Method for Preparing Gas Filtration Device

The hydroxylated graphene powder was used as a raw material, and the hydroxylated graphene powder was calendered under a pressure of 0.5 MPa to obtain a sheet, then the sheet was cut to obtain a filtration device including a self-supporting hydroxylated graphene powder layer.

### Embodiment 6: Method for Preparing Gas Filtration Device

The graphene powder, the carboxylated graphene powder, the graphene oxide powder and the mercapto graphene powder were used as raw materials. The above four powders of the same mass are taken, then the four powders are uniformly mixed and calendered under a pressure of 0.5 MPa to obtain a sheet. The sheet was cut to obtain a filtration device including a self-supporting powder layer of four graphene materials.

### Embodiment 7: Method for Preparing Gas Filtration Device

The graphene powder, the carboxylated graphene powder, the graphene oxide powder and the mercapto graphene powder were used as raw materials, and the meltblown polyester nonwoven fabric is used as a filtration aiding layer. The above four powders of the same mass are taken, then the four powders are uniformly mixed, sandwiched between the meltblown polyester nonwoven fabric, and calendered under a pressure of 0.5 MPa to obtain a sheet. The sheet was cut to obtain a filtration device including a self-supporting powder layer of four graphene materials.

### Embodiment 8: Method for Preparing Gas Filtration Device

The graphene powder, the carboxylated graphene powder, the graphene oxide powder and the mercapto graphene powder were used as raw materials, the meltblown polyester nonwoven fabric is used as a filtration aiding layer, and the pure cotton staple fiber filter cloth is used as an outer covering layer. The above four powders of the same mass are taken, then the four powders are uniformly mixed, sandwiched between the meltblown polyester nonwoven fabric, and calendered under a pressure of 0.5 MPa. Upon completion, the pure cotton staple fiber filter cloth is wrapped outside and stitched to obtain a sheet. Then, the sheet was cut to obtain a filtration device including a self-supporting powder layer of four graphene materials.

### Embodiment 9: Method for Preparing Gas Filtration Device

The graphene aerogel, the carboxylated graphene aerogel, the graphene oxide aerogel and the mercapto graphene aerogel were used as raw materials, the polypropylene needle punched nonwoven fabric is used as a filtration aiding layer, and the pure cotton gauze is used as an outer covering layer. The above four aerogels of the same mass are taken, uniformly mixed, calendered under a pressure of 0.2 MPa. Upon completion, the obtained product is sandwiched between the filtration aiding layers formed by the polypropylene needle punched nonwoven fabric, wrapped with the pure cotton gauze, and stitched to obtain a sheet. Then, the sheet was cut to obtain a filtration device including a self-supporting aerogel layer of four graphene materials.

### Embodiment 10 Detection of Removal Rate of Pollutants

Detection Device

FIG. 2 shows the structural schematic diagram of a device that is configured to detect the gas filtration. The device consists of the following five parts: gas filtration device b3; U-shaped absorbing tube b4; absorption solvent b5; aluminum oxide sieve plate b6; and air sampling pump b7. The role of each part is as follows:

gas filtration device b3: configured to filter the gas;

U-shaped absorbing tube b4: configured to support the absorption solvent b5 and prevent the solvent from being sucked into the air sampling device;

absorption solvent b5: configured to dissolve artificial smoke;

aluminum oxide sieve plate b6: configured to prevent back suction, specifically, the holes of the porous sieve plate are used for nucleate boiling, so that in the vacuum extracting process, the solvent can be boiled without directly going into the atmospheric sampling device; and

air sampler b7, namely the atmospheric sampling instrument: configured to extract vacuum and provide negative pressure; and also configured to store atmospheric samples in detections under certain conditions.

The device shown in FIG. 3 is configured to detect particulate matter filtration, which consists of the following two parts: a gas filtration device b1 and an air detection device b2. The role of each part is as follows:

gas filtering device b1: configured to filter gas; and

air detection device b2: configured to detect the amount of particulate matters in the gas.

Detection Method

Gas Pollutant Detection Method

(1) The gas filtration device b3 is set to be empty, the artificial smoke is directly absorbed by the absorption solvent b5, and the detection is stopped after the experiment lasts 5 minutes. The absorption solvent b5 is taken out, and the contents of the compound to be detected in the solvent after the absorption are detected by GC-MS, HPLC, ICP-MS, AAS or other detection methods to be used as a reference amount t0.

(2) Different gas filtration devices b3 are provided, the artificial smoke is absorbed by the absorption solvent b5 after passing through the gas filtration device b3, and the detection is stopped after the experiment lasts 5 minutes. The absorption solvent b5 is taken out, and the contents of the compound to be detected in the solvent after the absorption is detected by GC-MS, HPLC, ICP-MS, AAS or other detection methods to be used as a residual amount t1; and

(3) The gas pollutant removal rate is calculated: compound removal rate (%)=1−residual amount t1/reference amount t0.

Particulate Matter Detection Method

(1) The gas filtration device b1 is set to be empty, and the artificial smoke is directly detected by the air detection device b2 to obtain the content of the particulate matter, and the content is recorded as a reference amount k0;

(2) Different gas filtration devices b3 are provided, and the artificial smoke is detected by the air detection device b2 after passing through the gas filtration device b3 to obtain the content of the particulate matter, and the content is recorded as a residual amount k1; and

(3) A particulate matter removal rate is calculated: compound removal rate (%)=1−residual amount k1/reference amount k0.

Detection Samples

The gas filtration devices obtained in embodiments 1-4 and embodiments 6-7.

Detection Results

As shown in Table 1.

TABLE 2
Statistics on pollutant removal rate of different gas filtration devices

| Pollutant Type | Pollutant | Embodiment 1 | Embodiment 2 | Embodiment 3 | Embodiment 4 | Embodiment 6 | Embodiment 7 |
|---|---|---|---|---|---|---|---|
| PAHs | Naphthalene | 78.2% | 72.7% | 75.5% | 65.3% | 86.7% | 86.6% |
| (polycyclic | Benzo [a] | 100% | 94.4% | 89.9% | 74.0% | 100% | 100% |
| aromatic | pyrene | | | | | | |
| hydrocarbons) | Benzo [e] | 100% | 90.2% | 96.1% | 69.4% | 100% | 100% |
| | pyrene | | | | | | |
| | Benzo [b] | 100% | 91.1% | 98.0% | 66.7% | 99.4% | 99.6% |
| | fluoranthene | | | | | | |
| | Benzo [k] | 100% | 95.5% | 99.5% | 72.6% | 100% | 99.9% |
| | fluoranthene | | | | | | |
| | Benzo [j] | 100% | 92.8% | 99.3% | 75.8% | 99.7% | 100% |
| | fluoranthene | | | | | | |
| VOCs | Formaldehyde | 35.3% | 29.4% | 81.5% | 76.5% | 92.4% | 92.6% |
| | Benzene | 81.4% | 74.8% | 74.5% | 74.4% | 83.9% | 84.2% |
| | Xylene | 57.9% | 56.3% | 78.4% | 63.8% | 89.6% | 89.9% |
| | Styrene | 53.6% | 52.7% | 50.5% | 49.2% | 73.1% | 74.5% |
| | Trichloromethane | 36.8% | 32.9% | 64.4% | 62% | 76.9% | 76.5% |
| | Diisocyanate | 70.1% | 66.8% | 95.5% | 89.3% | 89.5% | 89.1% |
| Inorganic | Nitrogen | 80.4% | 76.5% | 65.3% | 57.3% | 90.5% | 90.4% |
| Gas | dioxide | | | | | | |
| | Sulfur | 85.5% | 85.8% | 89.2% | 83.1% | 91.0% | 90.5% |
| | dioxide | | | | | | |
| | Sulphur | 78.2% | 77.9% | 82.1% | 73.9% | 79.5% | 79.6% |
| | trioxide | | | | | | |
| | Hydrogen | 53.2% | 53.0% | 65.6% | 63.0% | 68.6% | 69.1% |
| | sulfide | | | | | | |
| | Hydrogen | 74.3% | 65.9% | 75.3% | 64.2% | 65.3% | 66.1% |
| | chloride | | | | | | |
| | Ammonia | 84.4% | 76.6% | 81.3% | 73.6% | 92.6% | 92.9% |
| | Ozone | 67.1% | 59.7% | 40.5% | 40.4% | 44.0% | 43.6% |
| | Carbon | 34.9% | 32.6% | 28.8% | 27.9% | 28.4% | 28.2% |
| | monoxide | | | | | | |
| Heavy Metal | Lead | 92.5% | 89.5% | 98.9% | 93.4% | 99.6% | 99.7% |
| Suspended | PM2.5 | 90.5% | 81.6% | 95.1% | 95.7% | 99.2% | 99.8% |
| Particles | PM10 | 99.8% | 99.3% | 99.8% | 99.9% | 100% | 100% |

The comparison between the pollutant removal rate of the gas filtration device of embodiment 1 and that of embodiment 3 shows that the gas filtration device including the self-supporting graphene aerogel material layer and the gas filtration device including the self-supporting graphene powder material layer provided by the present invention have different focus on the pollutants when filtering the gas. Both, the self-supporting graphene aerogel material layer and the self-supporting graphene powder material layer, have good removal effects on semi-volatile compounds such as PAHs etc., VOCs, inorganic gases, heavy metals, and suspended particles. However, the gas filtration device including the self-supporting graphene aerogel material layer has a relatively better removal effect on semi-volatile compounds such as PAHs etc., the removal rate is almost 100%. While, the gas filtration device including the self-supporting graphene powder material layer has a better removal effect on VOCs, heavy metals and suspended particles.

The comparison between the pollutant removal rate of the gas filtration device of embodiment 1 and that of embodiment 2 and the comparison between the pollutant removal rate of the gas filtration device of embodiment 3 and that of embodiment 4 show that the differences in calendering pressure when preparing the gas filtration device of the present invention have an effect on the removal rate of the pollutants. When the calendering pressure is lower than 0.15 MPa or higher than 0.5 MPa, although the gas filtration device as a whole still has a good effect of removing the pollutants, the filtration effect is lowered compared with the calendering pressure ranges from 0.15 MPa to 0.5 MPa.

The comparison between the pollutant removal rate of the gas filtration device of embodiment 3 and that of embodiment 6 shows that when the graphene material includes the graphene, the graphene oxide, the carboxylated graphene and the mercapto graphene, the effect of removing VOCs such as formaldehyde, etc., inorganic gases such as ammonia, etc., heavy metal such as lead, etc., and suspended particles by the gas filtration device of the present invention is further improved.

The comparison between the pollutant removal rate of the gas filtration device of embodiment 6 and that of embodiment 7 shows that when the gas filtration device of the present invention includes a filtration aiding layer, the effect of removing suspended particles, especially PM2.5, is further improved.

The gas filtration device and the air filtration system provided by the present invention have been described in detail above. The principles and implementations of the present invention have been described herein with reference to specific embodiments, and the description of the above embodiments is only intended to facilitate the understanding of the method and the core idea of the present invention. It should be noted that those skilled in the art can make various improvements and changes to the present invention without departing from the principles of the present invention, and these improvements and changes should be considered as falling within the scope of the appended claims of the present invention.

What is claimed is:

1. A gas filtration device, comprising:
a self-supporting graphene layer made of a graphene material;
wherein the graphene material comprises graphene and/or functionalized graphene; and
the functionalized grapheme comprises one or more items selected from the group consisting of aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide.

2. The gas filtration device of claim 1, wherein the self-supporting graphene layer is selected as a self-supporting graphene powder material layer and/or a self-supporting graphene aerogel material layer.

3. The gas filtration device of claim 1, wherein the graphene material comprises graphene, graphene oxide, carboxylated graphene and mercapto graphene.

4. The gas filtration device of claim 1, further comprising filtration aiding layers provided on a first side and a second side of the self-supporting graphene layer.

5. The gas filtration device of claim 4, further comprising outer covering layers provided on the outside of the filtration aiding layers.

6. A manufacturing method of a gas filtration device f claim 1, comprising placing a graphene powder material between filtration aiding layers, and calendering at a pressure ranges from 0.15 MPa to 0.5 MPa to obtain the gas filtration device.

7. A manufacturing method of a gas filtration device f claim 1, comprising calendering a graphene aerogel material at a pressure ranges from 0.15 MPa to 0.5 MPa to obtain the gas filtration device.

8. An air filtration system, comprising the gas filtration device of claim 1.

9. The air filtration system of claim 8, further comprising an ultraviolet device arranged between the gas filtration device and an air outlet of a gas filter.

10. The gas filtration device of claim 2, wherein the graphene material comprises graphene, graphene oxide, carboxylated graphene and mercapto graphene.

11. The gas filtration device of claim 2, further comprising filtration aiding layers provided on a first side and a second side of the self-supporting graphene layer.

12. The air filtration system of claim 8, wherein the self-supporting graphene layer is selected as a self-supporting graphene powder material layer and/or a self-supporting graphene aerogel material layer.

13. The air filtration system of claim 8, wherein the graphene material comprises graphene, graphene oxide, carboxylated graphene and mercapto graphene.

14. The air filtration system of claim 8, wherein the gas filtration device further comprises filtration aiding layers provided on a first side and a second side of the self-supporting graphene layer.

15. The air filtration system of claim 8, wherein the gas filtration device further comprises outer covering layers provided outside the filtration aiding layers.

16. The air filtration system of claim 12, further comprising an ultraviolet device arranged between the gas filtration device and an air outlet of a gas filter.

17. The air filtration system of claim 13, further comprising an ultraviolet device arranged between the gas filtration device and an air outlet of a gas filter.

18. The air filtration system of claim 14, further comprising an ultraviolet device arranged between the gas filtration device and an air outlet of a gas filter.

19. The air filtration system of claim 15, further comprising an ultraviolet device arranged between the gas filtration device and an air outlet of a gas filter.
